(19) United States
(12) Patent Application Publication
(10) Pub. No.: US 2026/0104280 A1
(43) Pub. Date: Apr. 16, 2026

(54) ELECTROMAGNETIC FLOWMETER

(71) Applicant: ABB SCHWEIZ AG, Baden (CH)

(72) Inventor: Caifu Fan, Shanghai (CN)

(21) Appl. No.: 19/421,633

(22) Filed: Dec. 16, 2025

Related U.S. Application Data
(63) Continuation of application No. PCT/CN2023/100711, filed on Jun. 16, 2023.

(51) Int. Cl. G01F 1/58

(52) U.S. Cl. CPC G01F 1/586

(57) ABSTRACT

An electromagnetic flowmeter includes a measurement pipe a pair; of exciting systems disposed on outer sides of the measurement pipe radially opposite to each other, each exciting system including an exciting coil generating a magnetic field according to a current supplied thereto and a magnetic conductive member arranged around the measurement pipe; a pair of electrodes disposed on inner wall surface of the measurement pipe radially opposite to each other and perpendicular to a magnetic field direction; wherein in a cross section of the measurement pipe, a wrap angle formed by the magnetic conductive member with respect to a center of the measurement pipe is in a range of 35 degrees to 70 degrees.

### FIELD

Embodiments of the present disclosure generally relate to an electromagnetic flowmeter.

### BACKGROUND

An electromagnetic flowmeter is widely used in various industrial fields, such as water treatment, food production, petroleum industry, and the like, and is used to measure a flow rate of a conductive fluid that flows inside a measurement pipe of the electromagnetic flowmeter. In the electromagnetic flowmeter, one or more excitation coil is provided outside the measurement pipe and is configured to generate a magnetic field in a direction perpendicular to a direction in which the conductive fluid flows. A pair of electrodes is arranged inside the measurement pipe and is configured to measure a voltage generated by the conductive fluid flowing within the magnetic field. The flow rate of the fluid is calculated on the basis of the measured voltage which is proportional to a velocity of the fluid that flows inside the measurement pipe.

However, the conventional electromagnetic flowmeter is subject to a poor measurement linearity between the electrode voltage difference and the flow rate. That is, a measurement error of the electromagnetic flowmeter varies when the fluid flows within the measurement pipe at a lower fluid velocity and at a higher velocity. In particular, when the fluid flows in a lower velocity range, this phenomenon is more significant, which causes a low precision at low flow rate. There is a need to further improve measurement performances of the electromagnetic flowmeter.

### SUMMARY

Example embodiments of the present disclosure provide an electromagnetic flowmeter which improves the measurement linearity of the electromagnetic flowmeter caused by variation of velocity profile of the fluid.

In a first aspect of the present disclosure, there is provided an electromagnetic flowmeter. The electromagnetic flowmeter comprises: a measurement pipe; a pair of exciting systems disposed on outer sides of the measurement pipe radially opposite to each other, each exciting system comprising an exciting coil generating a magnetic field according to a current supplied thereto and a magnetic conductive member arranged around the measurement pipe; a pair of electrodes disposed on inner wall surface of the measurement pipe radially opposite to each other and perpendicular to a magnetic field direction; wherein in a cross section of the measurement pipe, a wrap angle formed by the magnetic conductive member with respect to a center of the measurement pipe is in a range of 35 degrees to 70 degrees. According to the electromagnetic flowmeter of the present disclosure, the magnetic strength distribution within the measurement is optimized such that the measurement linearity of the electromagnetic flowmeter, for example, caused by variation of velocity profile of the fluid, is improved.

In some embodiments, the wrap angle may be in a range of 40 degrees to 65 degrees. With this arrangement, the measurement linearity of the electromagnetic flowmeter can be further improved.

In some embodiments, the magnetic conductive member may comprise a first lateral edge extending in a direction in which the measurement pipe extends; and a second lateral edge opposite to the first lateral edge, at least one of the first lateral edge and the second lateral edge being chamfered or rounded. With this arrangement, the abrupt change of the magnetic strength adjacent to the edge can be prevented.

In some embodiments, the exciting system further may comprise a magnetic core comprising a profiled part to which the magnetic conductive member is connected.

In some embodiments, the profiled part may comprise a third lateral edge extending in a direction in which the measurement pipe extends and a fourth lateral edge opposite to the third lateral edge, and the third lateral edge and the fourth lateral edge are chamfered.

In some embodiments, in the cross section of the measurement pipe, an angle formed by the third lateral edge and the fourth lateral edge may be in a range of 100 degrees to 130 degrees.

In some embodiments, the angle formed by the third lateral edge and the fourth lateral edge may be in a range of 110 degrees to 120 degrees.

In some embodiments, the magnetic conductive member may comprise a magnetic conductive sheet wrapped around the measurement pipe. With this arrangement, the sheet can be easily wrapped around the pipe.

In some embodiments, in each quadrant of the cross section of the measurement pipe, the magnetic conductive member may be configured to generate a first magnetic area adjacent to the first reference line and an adjacent second magnetic area adjacent to the second reference line, the cross section being divided into four quadrants by a first reference line connecting respective magnetic poles of the pair of exciting systems and a second reference line connecting the pair of electrodes; a magnetic flux density in the first magnetic area is greater than a magnetic flux density in the second magnetic area; a central angle of the first magnetic area with respect to the center of the measurement pipe is in a range of 20 degrees to 32.5 degrees; and a central angle of the second magnetic area with respect to the center of the measurement pipe is in a range of 57.5 degrees to 70 degrees.

In some embodiments, a magnetic flux density distribution within the first magnetic area is substantially uniform.

In some embodiments, in the cross section of the measurement pipe, a shape of the magnetic conductive member may be designed such that a magnetic flux density distribution of the magnetic field is substantially a reciprocal of a weight function of the electromagnetic flowmeter.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is an overall perspective view of an electromagnetic flowmeter according to one example embodiment of the present disclosure;

FIG. 2 is a axial plane view of the electromagnetic flowmeter according to one example embodiment of the present disclosure, showing main elements of the electromagnetic flowmeter;

FIG. 3 is a perspective view of an exciting system of the electromagnetic flowmeter according to one example embodiment of the present disclosure;

FIG. 4 is a plane view of the magnetic conductive member of the exciting system according to one example embodiment of the present disclosure;

FIG. 5 is a plane view of a magnetic core of the exciting system according to one example embodiment of the present disclosure; and

FIG. 6 is an ideal magnetic flux density distribution induced by the exciting system according to one example embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

As mentioned in background part of the present disclosure, measurement precision of an electromagnetic flowmeter is not constant but varies when the conductive fluid flows at different velocities. In some applications, when the conductive fluid flows at a low velocity range (for example, 0˜5 m/s), the measurement error of the electromagnetic flowmeter may be up to 1% or more; while the measurement error of the same electromagnetic flowmeter is lower, for example, up to 0.5 % or less, when the conductive fluid flows at a high velocity range (for example, 5 m/s or more). In some applications, when the electromagnetic flowmeter is mounted at different positions of a transport pipe, for example, a straight section of the pipe and a bent section of the pipe, the measurement result from the electromagnetic flowmeters may vary by up to 1%. Such a large measurement deviation does not meet industrial requirements. There is a need to improve the measurement linearity of the electromagnetic flowmeter caused by variation of velocity profile of the fluid. According to the present disclosure, the measurement linearity of the electromagnetic flowmeter is improved by changing a shape of a magnetic conductive member of the electromagnetic flowmeter to optimize magnetic field distribution.

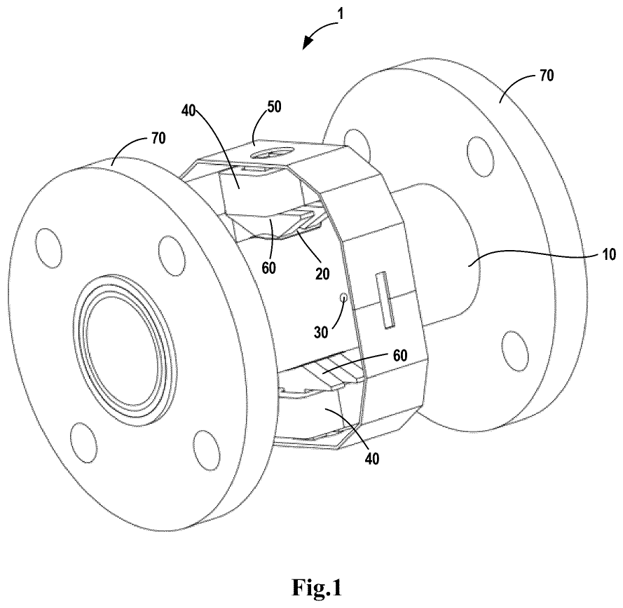

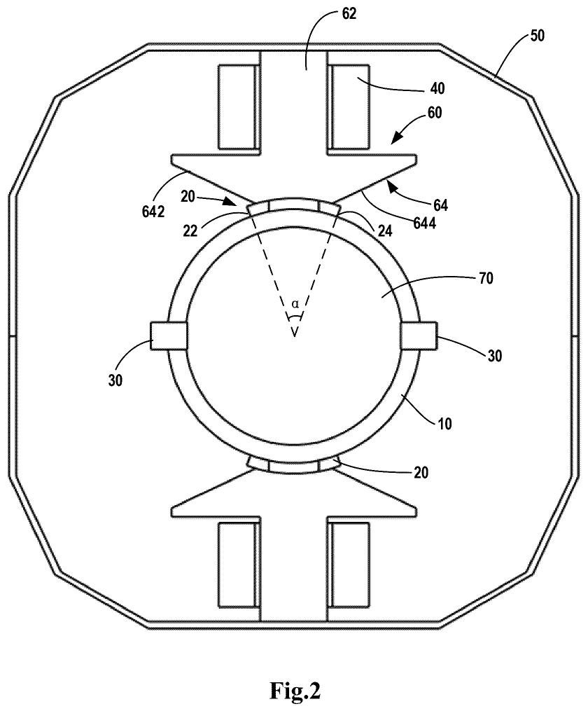

FIG. 1 is an overall perspective view of an electromagnetic flowmeter 1 according to one example embodiment of the present disclosure. FIG. 2 is an axial plane view of the electromagnetic flowmeter 1 according to one example embodiment of the present disclosure. As shown in FIGS. 1 and 2, the electromagnetic flowmeter 1 includes a measurement pipe 10 and a pair of exciting systems disposed on outer sides of the measurement pipe 10 radially opposite to each other. The electromagnetic flowmeter 1 may include a pair of end flanges 70 at the respective end of the measurement pipe 10. Via the end flanges 70, the measurement pipe is fluidly communicated to a fluid transport pipe (not shown).

The pair of exciting systems may include exciting coils 40 which generates a magnetic field according to a current supplied thereto (for example, a rectangular wave current). The pair of exciting systems may be of various forms. As shown in FIG. 2, in addition to the exciting coils 40, each exciting system may further include a magnetic core 60, a magnetic conductive member 20, and a magnetic return bracket 50. The exciting coils 40 may be wound around the magnetic core 60. The magnetic conductive member 20 is connected to one end of the magnetic core 60 and is arranged around an outer surface of the measurement pipe 10. The other end of the magnetic core 60 is connected to the magnetic return bracket 50. It is to be understood that the shown exciting system is merely illustrative. In some other embodiments, the magnetic core 60 may be omitted.

When the magnetic field is generated by coils which are excited by a current, the magnetic field passes the magnetic core 60 at one side, the magnetic conductive member 20 at the same side, the magnetic conductive member 20 at the other side, the magnetic conductive member 20 at the other side and the magnetic core 60 at the other side, and finally returns to the magnetic core 60 at one side via the magnetic return bracket 50. The magnetic field generated by the exciting coils 40 is thus applied across the measurement pipe 10 via the pair magnetic conductive member 20.

A pair of electrodes 30 is disposed on an inner wall surface of the measurement pipe 10. The pair of electrodes 30 is radially opposite to each other perpendicular to the magnetic field direction. When a conductive fluid flows inside the measurement pipe 10 of the electromagnetic flowmeter 1, a voltage is generated at the pair of electrodes 30. The generated voltage is proportional to a velocity of the fluid that flows inside the measurement pipe. By measuring and outputting the voltage generated at the electrodes 30, the flow rate of the conductive fluid inside the measurement pipe can be calculated based on the generated voltage.

As shown in FIG. 2, in a cross section of the measurement pipe 10, a wrap angle α formed by the magnetic conductive member 20 with respect to a center of the measurement pipe 10 is in a range of 35 degrees to 70 degrees. In some embodiments, the wrap angle α may be in a range of 40 degrees to 65 degrees. The term “wrap angle” refers to an angle formed by the respective lateral edge of the magnetic conductive member 20 with respect to the center of the measurement pipe 10. The wrap angle is determined by a circumferential size of the magnetic conductive member 20 and has direct influences on the magnetic flux distribution. The magnetic conductive member 20 with the above wrap angle is shown to improve measurement linearity of the electromagnetic flowmeter. Thus, the performances of the electromagnetic flowmeter are improved.

The underlying principle of how the wrap angle of the magnetic conductive member 20 improves the measurement linearity of the electromagnetic flowmeter is illustrated below. After keen study of the linearity of the electromagnetic flowmeter due to variation of velocity profiles, the inventors of the present disclosure find that the linearity is related to a weight function. The weight function represents an effect of the induced electrical potential generated by any tiny fluid element cutting the magnetic force line in the magnetic field on an electrical potential difference between the two electrodes. Put it in another way, the weight function refers to an attenuation coefficient caused by the geometric position that the electromotive force generated by each point in the magnetic field cannot contribute equivalently to the voltage between the two electrodes.

As the magnetic flux density of the magnetic field within the measurement pipe times the weight function is a constant, an ideal magnetic field distribution within the measurement pipe should be a reciprocal of the weight function. According to the magnetic path of the electromagnetic flowmeter, a shape of magnetic conductive member 20 is essential to the magnetic field strength within the pipe. As the weight function is small at the positions that are away from the electrodes, the magnetic field should be strengthened at these positions to compensate the weight function. When the wrap angle α of the magnetic conductive member 20 is in a range of 35 degrees to 70 degrees, the magnetic conductive member 20 is arranged to guarantee that a magnetic field strength is maximized where the weight function is minimum in the cross section of the pipe. Simulation and experimental data both show an obvious improvement on linearity. The electromagnetic flowmeter is shown to have a higher precision even the fluid flows at a low velocity. Thus, the measurement precision of the electromagnetic flowmeter is improved. Also, the electromagnetic flowmeter can be mounted to any positions of the fluid transport pipe, both the bent section and the straight section.

In some embodiments, the magnetic conductive member 20 may be of a sheet form. This may be advantageous for fitting around the pipe. In some embodiments, a shape of the magnetic conductive member 20 may be further modified to prevent a local magnetic strength adjacent to the lateral edge from abrupt change.

As shown in FIGS. 2-4, the magnetic conductive member 20 may include a first lateral edge 22 extends and a second lateral edge 24 opposite to the first lateral edge. The first lateral edge 22 and the second lateral edge 24 extend in a direction in which the measurement pipe 10. As seen in the cross section of the pipe, the positions of first lateral edge 22 and the second lateral edge 24 corresponds to the end boundaries of the magnetic field. The first lateral edge 22 and the second lateral edge 24 may be chamfered or rounded. In this way, sharp edges at the end boundaries can be avoided, which is advantageous in facilitating uniform magnetic field strength. In the shown example, the first lateral edge 22 and the second lateral edge 24 may be chamfered. It is to be understood that the shown example is merely illustrative and the first lateral edge 22 and the second lateral edge 24 may be of any other proper shapes.

In some embodiments, a shape of the magnetic core 60 is optimized to reduce a local magnetic strength away from the magnetic conductive member 20 without comprising the local magnetic strength near the magnetic conductive member 20.

As shown in FIGS. 2, 3, and 5, two magnetic cores 60 are provided in parallel lengthwise along the pipe. The magnetic core may include a post 62 and a profiled part 64. Around the post 62, the coil 40 is wound. In some embodiments, the post may be omitted. The profiled part 64 may be integrally formed with the post 62. The profiled part 64 is provided adjacent to the conductive member 20. The conductive member 20 may be mechanically fixed to the two magnetic cores 60 with no air gaps. Thus, the magnetics force can be efficiently transmitted from the profiled part 64 to the conductive member 20. In some embodiments, the profiled part 64 is shaped to have a reduced magnetic strength adjacent to the conductive member 20, for example, by material removal. This is advantageous for reducing magnetic strength in an area that is closer to the electrodes and far away from the magnetic pole.

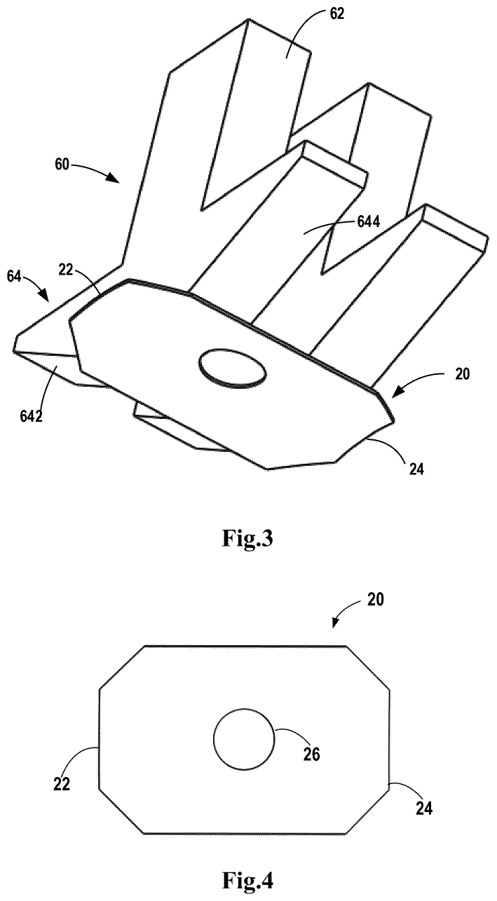

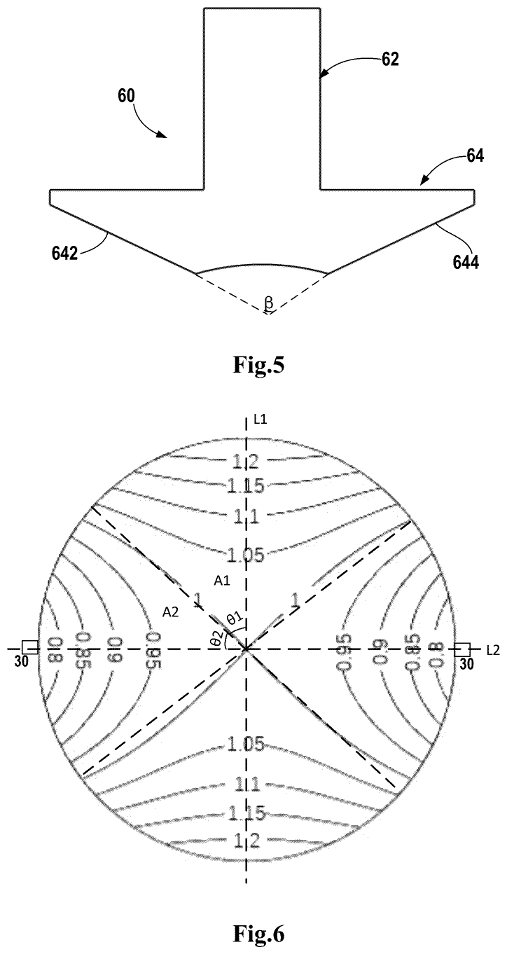

In some embodiments, as seen in the cross section of the measurement pipe 10, the profiled part 64 may be of a substantially trapezoidal shape. The closer the profiled part 64 gets to the pipe, the lesser material the profiled part 64 has. As shown in FIGS. 3 and 5, in the cross section of the measurement pipe 10, the profiled part 64 comprises a lateral edge 642 and a lateral edge 644 opposite to the lateral edge 642. Both the lateral edges 642, 644 extend lengthwise along the pipe. The lateral edge 642 and the lateral edge 644 are chamfered. As shown in FIG. 5, an angle β formed by the lateral edge 642 and the lateral edge 644 may be in a range of 100 degrees to 130 degrees. In some other embodiments, the angle β may be in a range of 110 degrees to 120 degrees. Simulation and experimental data both show an obvious improvement on linearity. It is to be understood that the shown example is merely illustrative and the lateral edge 642 and the lateral edge 644 may be of any other proper shapes.

FIG. 6 is an ideal magnetic flux density distribution induced by the exciting system according to one example embodiment of the present disclosure.

As show in FIG. 6, in the cross section of the measurement pipe 10, a first reference line L1 connects respective magnetic poles of the pair of exciting systems, and a second reference line L2 connects the pair of electrodes 30. The extending direction of L1 is corresponding to the magnetic field direction. The extending direction of L2 is corresponding to the direction in which the electrodes 30 are arranged. In the area adjacent to the first reference line L1, the isomagnetic lines are of large numeral values 1.05, 1.1, 1.15, 1.2, while in the area adjacent to the second reference line L1, the isomagnetic lines are of smaller numeral values 0.8, 0.85, 0.9, 0.95. The larger the numeral value is, the large the magnetic strength is. In some embodiments, a shape of the magnetic conductive member 20 is designed such that a magnetic flux density distribution of the magnetic field is substantially a reciprocal of a weight function of the electromagnetic flowmeter.

The cross section of the measurement pipe 10 is divided thus into four quadrants by a reference lines L1, L2. Within each quadrant, taken the left-upper quadrant as an example, the first magnetic area A1 is adjacent to the first reference line L1. The adjacent second magnetic area A2 is adjacent to the second reference line L2. In some embodiments, the shape of the magnetic conductive member 20 is configured such that a magnetic flux density in the first magnetic area A1 is larger than a magnetic flux density in the adjacent second magnetic area A2. A central angle θ1 of the first magnetic area A1 with respect to the center of the measurement pipe 10 is in a range of 20 degrees to 32.5 degrees. In some embodiments, a central angle θ2 of the second magnetic area A2 with respect to the center of the measurement pipe 10 is in a range of 57.5 degree to 70 degree. Simulation and experimental data both show an obvious improvement on linearity. In some embodiments, the shape of the magnetic conductive member 20 is configured such that a magnetic flux density distribution within the first magnetic area A1 is substantially uniform.

Through the teachings provided herein in the above description and relevant drawings, many modifications and other embodiments of the disclosure given herein will be appreciated by those skilled in the art to which the disclosure pertains. Therefore, it is understood that the embodiments of the disclosure are not limited to the specific embodiments of the disclosure, and the modifications and other embodiments are intended to fall within the scope of the disclosure. In addition, while exemplary embodiments have been described in the above description and relevant drawings in the context of some illustrative combinations of components and/or functions, it should be realized that different combinations of components and/or functions can be provided in alternative embodiments without departing from the scope of the disclosure. In this regard, for example, it is anticipated that other combinations of components and/or functions that are different from the above definitely described will also fall within the scope of the disclosure. While specific terms are used herein, they are only used in a general and descriptive sense rather than limiting.

1. An electromagnetic flowmeter comprising:
a measurement pipe;
a pair of exciting systems disposed on outer sides of the measurement pipe radially opposite to each other, each exciting system comprising an exciting coil generating a magnetic field according to a current supplied thereto and a magnetic conductive member arranged around the measurement pipe;
a pair of electrodes disposed on inner wall surface of the measurement pipe radially opposite to each other and perpendicular to a magnetic field direction;
wherein in a cross section of the measurement pipe, a wrap angle formed by the magnetic conductive member with respect to a center of the measurement pipe is in a range of 35 degrees to 70 degrees.

2. The electromagnetic flowmeter according to claim 1, wherein the wrap angle is in a range of 40 degrees to 65 degrees.

3. The electromagnetic flowmeter according to claim 1, wherein the magnetic conductive member comprises:
a first lateral edge extending in a direction in which the measurement pipe extends; and
a second lateral edge opposite to the first lateral edge, at least one of the first lateral edge and the second lateral edge being chamfered or rounded.

4. The electromagnetic flowmeter according to claim 1, wherein the exciting system further comprises a magnetic core comprising a profiled part to which the magnetic conductive member is connected.

5. The electromagnetic flowmeter according to claim 4, wherein the profiled part comprises a third lateral edge extending in a direction in which the measurement pipe extends and a fourth lateral edge opposite to the third lateral edge, and the third lateral edge and the fourth lateral edge are chamfered.

6. The electromagnetic flowmeter according to claim 5, wherein in the cross section of the measurement pipe, an angle formed by the third lateral edge and the fourth lateral edge is in a range of 100 degrees to 130 degrees.

7. The electromagnetic flowmeter according to claim 6, wherein the angle formed by the third lateral edge and the fourth lateral edge is in a range of 110 degrees to 120 degrees.

8. The electromagnetic flowmeter according to claim 1, wherein the magnetic conductive member comprises a magnetic conductive sheet wrapped around the measurement pipe.

9. The electromagnetic flowmeter according to claim 1, wherein:
in each quadrant of the cross section of the measurement pipe, the magnetic conductive member is configured to generate a first magnetic area adjacent to a first reference line and an adjacent second magnetic area adjacent to a second reference line, the cross section being divided into four quadrants by a first reference line connecting respective magnetic poles of the pair of exciting systems and a second reference line connecting the pair of electrodes;
a magnetic flux density in the first magnetic area is greater than a magnetic flux density in the second magnetic area;
a central angle of the first magnetic area with respect to the center of the measurement pipe is in a range of 20 degrees to 32.5 degrees; and
a central angle of the second magnetic area with respect to the center of the measurement pipe is in a range of 57.5 degrees to 70 degrees.

10. The electromagnetic flowmeter according to claim 9, wherein a magnetic flux density distribution within the first magnetic area is substantially uniform.

11. The electromagnetic flowmeter according to claim 1, wherein in the cross section of the measurement pipe, a shape of the magnetic conductive member is designed such that a magnetic flux density distribution of the magnetic field is substantially a reciprocal of a weight function of the electromagnetic flowmeter.
